(19) United States
(12) Patent Application Publication
(10) Pub. No.: US 2008/0068413 A1
(43) Pub. Date: Mar. 20, 2008

(54) PAGE WIDTH IMAGE FORMING APPARATUS

(75) Inventor: Masahiko Habuka, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/856,591

(22) Filed: Sep. 17, 2007

(30) Foreign Application Priority Data
Sep. 18, 2006 (KR) 2006-90142

(51) Int. Cl. B41J 29/38

(52) U.S. Cl. 347/13

(57) ABSTRACT

An image forming apparatus and method, the apparatus including: a paper feeding unit to supply a print medium in a first direction; a line head unit comprising a nozzle unit including a plurality of nozzles; a head supporting unit to shift the line head unit in a second direction crossing the first direction; a discharging unit on which the print medium on which an image is formed by the line head unit is discharged; a paper transferring unit to supply the print medium to the line head unit n number of times so that an image can be repeatedly formed for the n number of times; and a controller to control the head supporting unit to shift the line head unit in the second direction n number of times.

### CROSS-REFERENCE TO RELATED APPLICATION

This application claims the benefit of Korean Application No. 2006-90142, filed Sep. 18, 2006 in the Korean Intellectual Property Office, the disclosure of which is incorporated herein by reference.

### BACKGROUND OF THE INVENTION

1. Field of the Invention

Aspects of the present invention relate to an image forming apparatus, and more particularly, to a page width image forming apparatus capable of compensating for image deterioration.

2. Description of the Related Art

In general, an image forming apparatus jets ink droplets from an ink cartridge in which ink is stored, and forms an image on a print medium there from. Image forming apparatuses can be classified, according to an ink jetting method of the ink cartridge, into shuttle type image forming apparatuses and line type image forming apparatuses. In the shuttle-type image forming apparatus, the ink cartridge moves laterally along a direction of a width of the print medium to jet ink on a print medium. On the other hand, in the line-type image forming apparatus, a plurality of nozzles are provided in the ink cartridge in a row to correspond to the width of the print medium, and the nozzles simultaneously jet ink droplets.

In the shuttle-type image forming apparatus, the ink cartridge moves within a distance corresponding to the width of the print medium, a process that takes time. As a result, time needed to form the image is greater than that in the line-type image forming apparatus. Accordingly, the shuttle-type image forming apparatus is limited in increasing the image forming speed. However, recently the line-type image forming apparatus has been under development so as to increase the image forming speed.

In the conventional line-type image forming apparatus 10, as shown in FIG. 1, if a particular nozzle 14 is damaged, a white line appears on the print medium when the ink is jetted onto the print medium through the plurality of nozzles 12 because ink is not jetted through the damaged nozzle 14. The white line becomes more visible as a printing density of an image becomes higher. Moreover, in the conventional line-type image forming apparatus 10, the image is formed by jetting ink through the plurality of nozzles 12 one time. As a result, it is difficult to correct a printing error such as the aforementioned white line generated on the print medium.

### SUMMARY OF THE INVENTION

Accordingly, aspects of the present invention provide a page width image forming apparatus capable of enhancing an image quality by forming an image on a print medium for a plurality of times.

Furthermore, aspects of the present invention provide an image forming apparatus capable of compensating for an inferior image quality by moving a line head in a sub scanning direction when forming an image.

According to an aspect of the present invention, there is provided an image forming apparatus including: a paper feeding unit to supply a print medium in a first direction; a line head unit including a nozzle unit that includes a plurality of nozzles; a head supporting unit to shift the line head unit in a second direction crossing the first direction; a discharging unit on which the print medium on which an image is formed by the line head unit is discharged; a paper transferring unit to supply the print medium to the line head unit n number of times so that an image can be repeatedly formed the n number of times; and a controller to control the head supporting unit to shift the line head unit in the second direction the n number of times.

According to an embodiment of the present invention, the nozzle unit may be organized into a plurality of nozzle areas, each including a number of the nozzles, and the controller may control the head supporting unit to shift the line head unit when forming the image so that a difference of ink jetting characteristics among nozzle areas corresponding to reference areas of the print medium over the n number of times is minimized.

According to an embodiment of the present invention, the ink jetting characteristics may include at least one of a number of defective nozzles included in each nozzle area, an amount of ink jetted in each nozzle area, and an image density on the print medium corresponding to each nozzle area.

According to an embodiment of the present invention, the image forming apparatus may further include: a sensor unit to sense the ink jetting characteristics of each nozzle; and a storing unit to store the ink jetting characteristics of each nozzle sensed by the sensor unit.

According to an embodiment of the present invention, the controller may calculate a number of possible shifts in which the line head unit can be shifted on the basis of the n number of times that the image is formed and the number of the nozzles included in each of the nozzle areas; add, for each of the nozzle areas corresponding to the reference areas of the print medium in each of the possible shifts, the ink jetting characteristics of the respective nozzle area; determine a best shift where the difference of the ink jetting characteristics among the nozzle areas corresponding to the reference areas of the print medium on the basis of the added ink jetting characteristics is a lowest value from among each of the possible shifts; and controls the head supporting unit to shift the line head unit according to the best shift.

According to an embodiment of the present invention, when the ink jetting characteristic includes the number of the defective nozzles and the difference of the ink jetting characteristics is the lowest value for more than one of the possible shifts, the controller may determine the best shift where a number of the defective nozzles in the nozzle areas corresponding to the reference areas of the print medium is a lowest value from among each of the possible shifts.

According to an embodiment of the present invention, when the ink jetting characteristic includes the amount of ink jetted through the nozzles and the difference of the ink jetting characteristics is the lowest value for more than one of the possible shifts, the controller may determine the best shift where a sum of the amount of ink jetted in the nozzle areas corresponding to the reference areas of the print medium is a highest value from among each of the possible shifts.

According to an embodiment of the present invention, the nozzle unit may include a plurality of head units each including one or more nozzles, and the line head unit has a width that is greater than a width of the print medium by as much as a half of a width of one head unit.

According to an embodiment of the present invention, the controller may control the head supporting unit to shift the line head unit by at least one nozzle area.

According to an embodiment of the present invention, the controller may control the head supporting unit so that a maximum single shift of the line head unit can not exceed a fourth of a width of one head unit.

According to an embodiment of the present invention, the controller may organize the nozzle unit into the plurality of nozzle areas so that a first nozzle having a first ink jetting characteristic is placed in a first nozzle area and a second nozzle having a second ink jetting characteristic is placed in a second nozzle area, and the first ink jetting characteristic and the second ink jetting characteristic are different than a predetermined ink jetting characteristic.

According to an embodiment of the present invention, the controller may organize the nozzle unit into the plurality of nozzle areas so that each of the nozzle areas includes at least four of the nozzles.

According to another aspect of the present invention, there is provided an image forming apparatus including: a line head unit including a nozzle unit that includes a plurality of nozzles; a head supporting unit to shift the line head unit; and a controller to control the head supporting unit to shift the line head unit when forming an image on a print medium according to ink jetting characteristics among nozzles corresponding to reference areas of the print medium.

According to another aspect of the present invention, there is provided a method of forming an image on a print medium, the method including: determining ink jetting characteristics of nozzles included in a nozzle unit provided in a line head unit; and shifting the line head unit including the nozzle unit when forming the image according to the ink jetting characteristics among nozzles corresponding to reference areas of the print medium.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction from the following description of the embodiments, taken in conjunction with the accompanying drawings, in which:

FIG. 1 is a view illustrating an ink jetting process of a conventional image forming apparatus;

FIG. 2 is a sectional view illustrating a configuration of an image forming apparatus according to an embodiment of the present invention;

FIG. 3 is a block diagram of the image forming apparatus according to an embodiment of the present invention;

FIGS. 4A and 4B are plan views illustrating a configuration of a nozzle unit of a line head unit according to an embodiment of the present invention;

FIGS. 5A and 5B are perspective views illustrating a configuration of the line head unit according to an embodiment of the present invention;

FIGS. 6A and 6B are flowcharts illustrating methods for determining the best shift of the image forming apparatus according to an embodiment of the present invention;

FIG. 7 is a flowchart illustrating an image forming process of the image forming apparatus according to an embodiment of the present invention; and

FIGS. 8A through 8F are views illustrating methods for determining the best shift of the image forming apparatus according to an embodiment of the present invention.

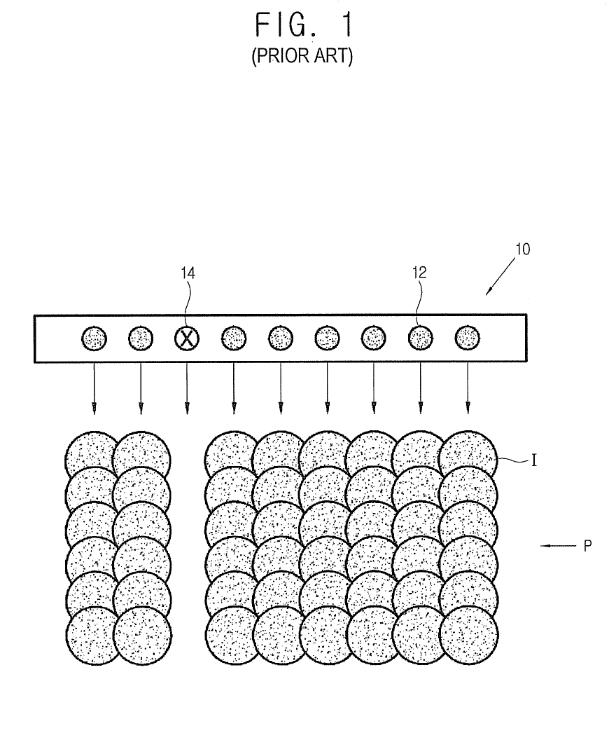

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

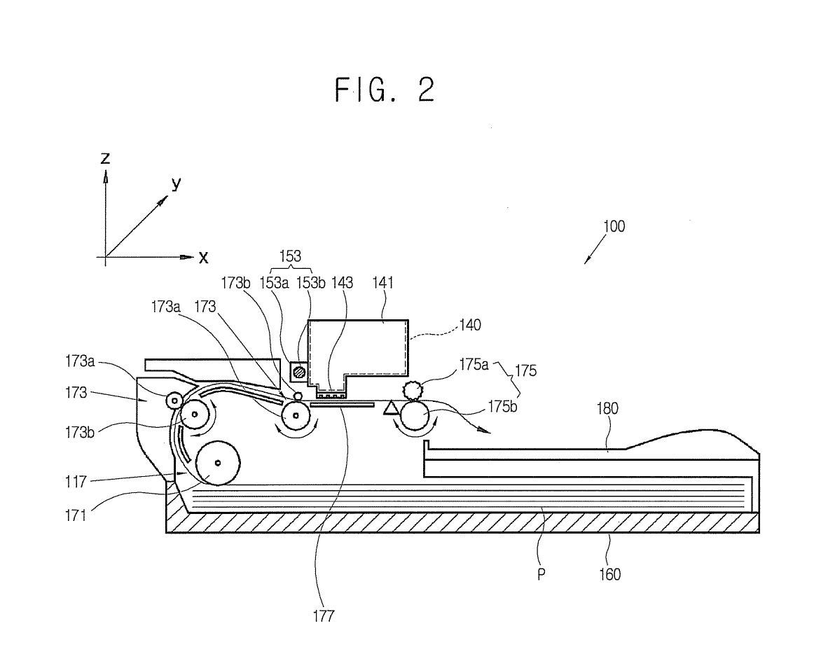

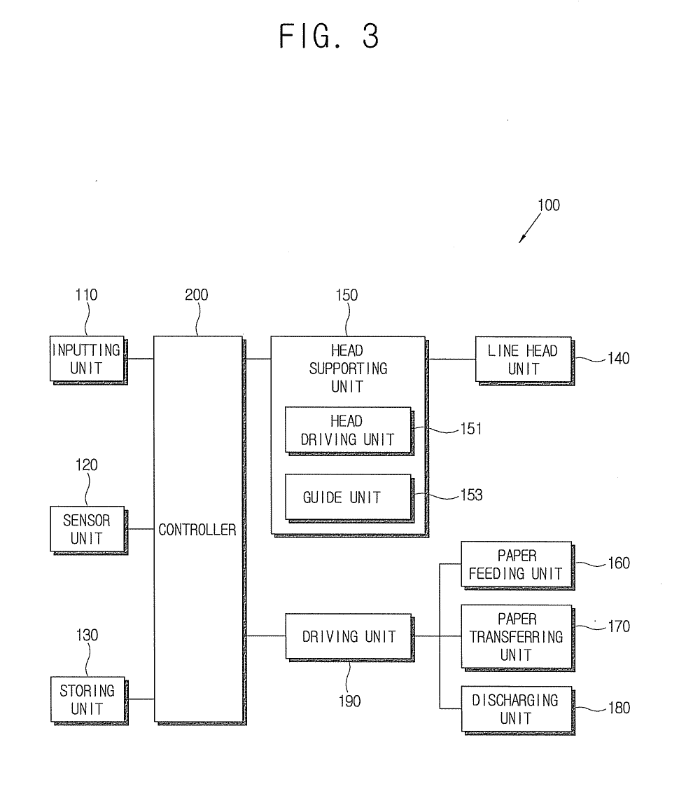

FIGS. 2 and 3 are a sectional view and a block diagram, respectively, illustrating a configuration of an image forming apparatus 100. As shown in FIGS. 2 and 3, the image forming apparatus 100 according to an embodiment of the present invention includes: an inputting unit 110 to generate a signal corresponding to an input or manipulation of a user; a sensor unit 120 to sense ink jetting characteristics; a storing unit 130 to store the ink jetting characteristics sensed by the sensor unit 120; a paper feeding unit 160 to feed a stored print medium P in a first direction; a paper transferring unit 170 to transfer print media P to a line head unit 140 n number of times; the line head unit 140 to form an image on the print media P transferred from the paper transferring unit 170; a discharging unit 180 to which the print media P on which images are formed in the line head unit 140 are discharged; and a controller 200 to determine the ink jetting characteristics of nozzles of the line head unit 140 and to control a head supporting unit 150 to shift the line head unit 140. It is understood that the paper feeding unit 160, the paper transferring unit 170, the discharging unit 180, and any reference to paper or paper units are not limited to use with paper, but may be applied to any print medium (such as paper, transparencies, etc.) used in the image forming apparatus 100. Further, the image forming apparatus 100 can include additional capabilities, such as scanning, copying, and/or faxing in other aspects of the invention.

The inputting unit 110 generates a signal corresponding to an input or manipulation of a user. The inputting unit 110 receives the image-forming frequency of the line head unit 140 from the user to inform the controller 200 of the frequency (i.e., the number of times that the image is formed on a print medium). At this time, if the user does not input the image-forming frequency, the image can be formed according to another frequency, such as a frequency stored as a default value or a last frequency inputted. The inputting unit 110 is provided on an exterior surface of the image forming apparatus 100. The inputting unit 110 may include an inputting panel to be manipulated by the user, and a display panel to display an operation of the image forming apparatus 100. Furthermore, the inputting unit 110 may include a plurality of buttons or a touch screen to receive inputs or a manipulation by the user. It is understood that according to other aspects, the inputting unit 110 may be on another device (such as a remote controller or a computer) connected to the image forming apparatus 100.

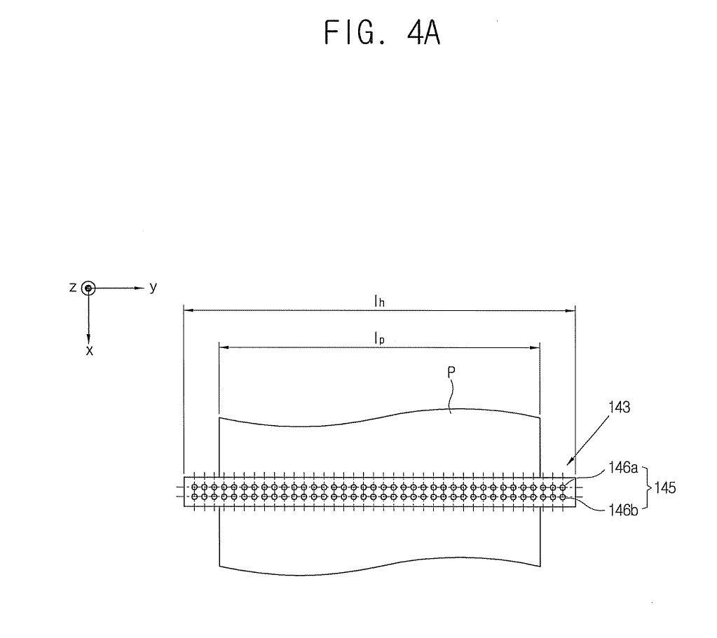

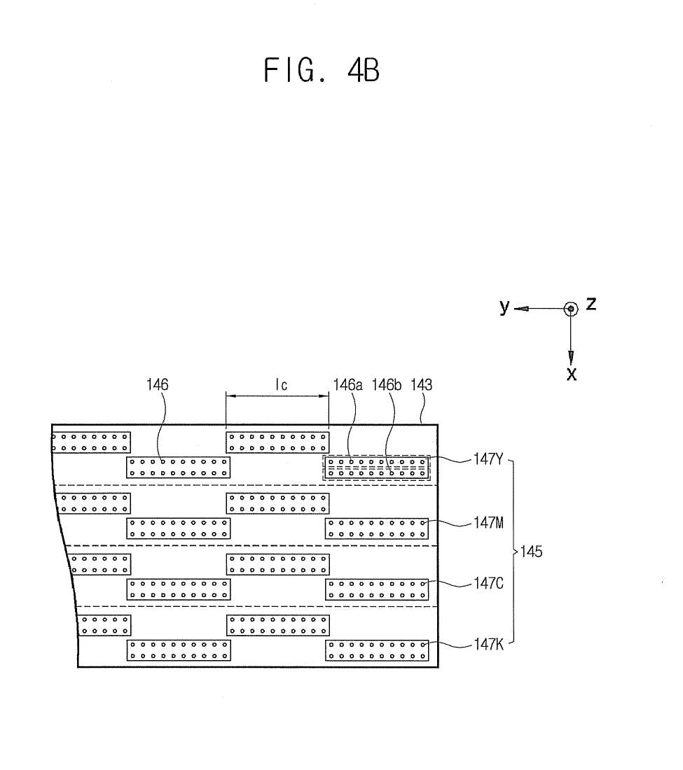

The sensor unit 120 senses ink jetting characteristics of the nozzle unit 145 of the line head unit 140, as shown in FIGS. 4A and 4B, according to a controlling signal of the controller 200. Here, the ink jetting characteristics may include data on whether there are one or more defective nozzles from among the nozzles 146 of the nozzle unit 145, the amount of ink jetted through the respective nozzles 146, and the printing density of an image printed on the print medium P through the nozzles 146, although not limited thereto.

The defective nozzle may be a nozzle that can not jet ink normally, such as a missing nozzle incapable of jetting ink or a weak nozzle having a weakened function. The defectiveness of the nozzle, which may result from a disconnection of a heater operating to jet ink, a malfunctioning driving circuit, or a damaged electric configuration element (such as a field emission transistor (FET)), can be easily sensed. Similarly, if the ink is jetted by driving of a piezo element, the defectiveness of the nozzles generated by the defectiveness of the piezo element itself or damage to the driving circuit for driving the piezo element can be easily sensed. In general, if the nozzle is defective, a test page may be printed to inspect the defectiveness. Since a portion of the test page printed through the defective nozzle has a low printing density, the defective printing can be easily sensed by using the sensor unit 120 (such as a light sensor). The light sensor includes a light emitting sensor (such as a light emitting diode) to emit light to the print medium P and a light receiving sensor to receive the light reflected from the print medium P. The outputting signal from the light receiving sensor is transferred to the controller 200. The light emitting sensor and the light receiving sensor may be integrally or separately provided. Here, the description of the configuration and the operation of the light sensor itself will be omitted since it is known to those skilled in the art. It is understood that, according to other aspects, the defectiveness of the nozzles may be detected by other methods, such as including sensors on the nozzles.

If the sensor unit 120 senses the amount of ink jetting and the density of the ink, the amount or the printing density of the ink jetted from the nozzles can be measured. The amount or the density of the ink may be sensed by reading the test page through the light sensor, as described above, or by other methods. Meanwhile, if the sensor unit 120 can not measure the amount of ink jetting, a general distribution tendency of ink-jetting for each nozzle may be stored in advance, and the stored ink-jetting distribution may be applied to the nozzles.

Also, the sensor unit 120 may combine a measurement of the amount of the ink jetted through the respective nozzles and the general ink-jetting distribution, to thereby preset the ink-jetting amount of the respective nozzles. Moreover, if the sensor unit 120 senses the number of defective nozzles, the number of the sensed defective nozzles and the general ink-jetting distribution may be combined to preset the amount of the ink jetted through the respective nozzles.

The storing unit 130 stores ink jetting characteristics of the respective nozzles sensed in the sensor unit 120. Also, the storing unit 130 stores image data received from a host (not shown). The storing unit 130 may be provided as a volatile memory (such as RAM) or a nonvolatile memory (such as ROM, flash memory, or a hard disk drive). Furthermore, it is understood that according to other aspects, the storing unit may be separately provided to transmit and receive the data, ink jetting characteristics, etc. through a wired or wireless connection.

The line head unit 140 jets ink on the print medium P to print an image on the print medium P. The line head unit 140 includes a head main body 141 in which ink is stored, and a line head 143 that is provided, for example, on a bottom of the head main body 141 and includes a plurality of nozzles.

As shown in FIGS. 4A and 4B, the line head 143 is provided with a nozzle unit 145 having a plurality of nozzles 146 jetting ink onto the print medium P. The line head 143 may use a heater or a piezo element as a driving source to jet ink. The line head 143 may be manufactured to have a high resolution by a semiconductor manufacturing process (such as etching, vacuum-deposition, and sputtering). Also, the nozzle unit 145 includes a plurality of nozzle arrays 146a, 146b jetting ink on the print medium P to print an image thereon. The length (Iₕ) of the nozzle unit 145 may be provided longer than the width (Iₚ) of the print medium P. The nozzle unit 145 may be installed in a second direction (y) with respect to a first direction (x) that denotes a print medium transferring direction. Here, the line head 143 may be provided to be perpendicular with the first direction (x).

As shown in FIG. 4A, in the nozzle unit 145, the nozzles 146 are disposed in successive arrays 146a and 146b. The size of the nozzles 146 may be provided uniformly or non-uniformly. Also, as shown in the embodiment in FIG. 4B, the nozzle unit 145 is organized into head units 147Y, 147M, 147C, and 147K, each including ones of the plurality of nozzles 146. The head units 147Y, 147M, 147C, and 147K may be disposed in an unaligned arrangement. For example, the head units 147Y, 147M, 147C, and 147K may be separately arranged according to respective colors. At this time, the length (Iₕ) of the nozzle unit 145 may be provided such that the nozzle unit 145 extends over opposite sides of the width of the print medium P as much as, for example, a half of a length (I_{c}) of one of the head units 147Y, 147M, 147C, and 147K. As a result, the nozzles 146 correspond to the width (Iₚ) of the print medium P even when the line head unit 140 is maximally shifted. While not required, the head units 147Y, 147M, 147C, and 147K can be chips, and other numbers of units and/or colors can be used.

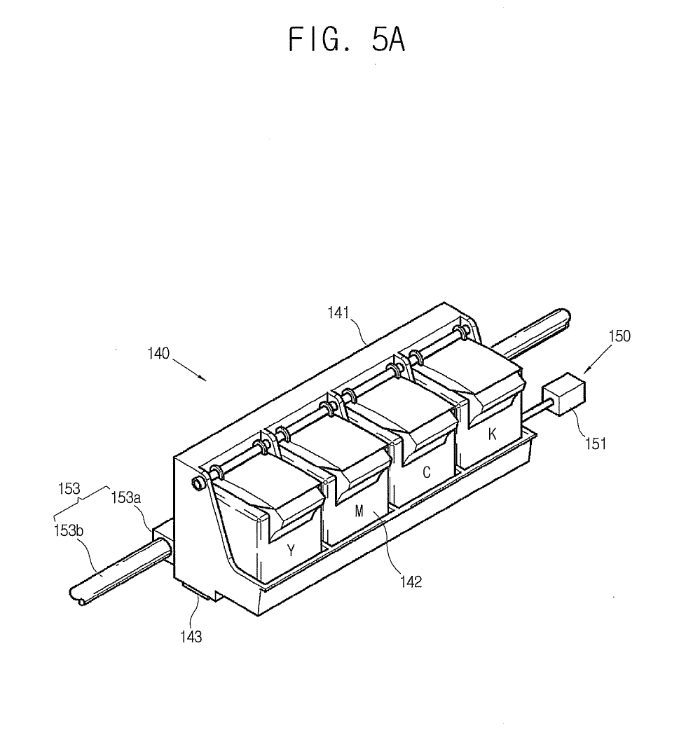

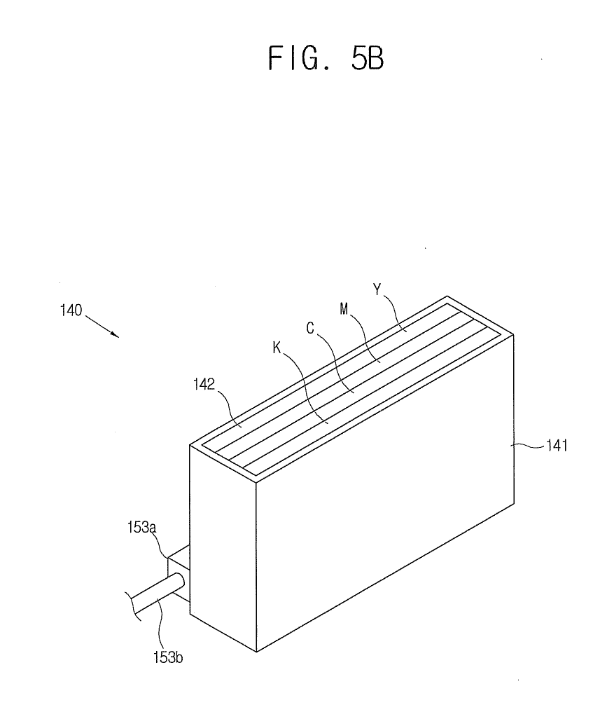

As shown in FIGS. 5A and 5B, the head main body 141 includes an ink cartridge 142 to accommodate ink. In the ink cartridge 142, the respective ink cartridges 142Y, 142M, 142C, and 142K are arranged side by side (as shown in FIG. 5A), or may be arranged in parallel having a length corresponding to the width of the print medium P (as shown in the embodiment in FIG. 5B). The head main body 141 may further include a chamber to accommodate a jetting unit (such as a piezo element) and/or a heater for a heat driving method that supplies pressure to jet ink, an ink flowing channel (such as an orifice) to supply ink accommodated in the head main body 141 to the chamber, a manifold provided as a common ink flowing channel to supply the ink from the ink flowing channel to each chamber, and a restrictor provided as a separate ink flowing channel to supply the ink from the manifold to each chamber. The description of the chamber, the ink jetting method unit, the ink flowing channel, the manifold, and the restrictor will be omitted as they are known to those skilled in the art. Moreover, it is understood that other arrangements and arrays can be used for the nozzles 146 and cartridge 142.

The head supporting unit 150 shifts the line head unit 140 when forming an image according to a controlling signal of the controller 200. As shown in FIG. 5A, the head supporting unit 150 includes a head driving unit 151 to shift the line head unit 140 according to the controlling signal of the controller 200, and a guide unit 153 to guide the shift of the line head unit 140.

The head driving unit 151 is supplied with an operating power from a power supplying unit (not shown). The head driving unit 151 is coupled with the line head unit 140 and reciprocally moves the line head unit 140 in a second direction. The head driving unit 151, according to an embodiment of the present invention, may use a piezo element actuator to drive a precise element such as an optical mirror. The piezo element is driven by voltage, required to have a precise position within a several allowance of μm, and a high frequency response characteristic. Accordingly, if the piezo element actuator is used as the head driving unit 151, the transferred line head unit 140 can be shifted precisely on a desirable position of the print medium P. However, it is understood that according to other aspects, a belt and a belt pulley, a rack and a pinion, or other known technologies for a relative movement can be used for the head driving unit 151.

The guide unit 153 guides the line head unit 140 reciprocally moved by the head driving unit 151. The guide unit 153 includes a coupling unit 153a and a guide shaft 153b. The coupling unit 153a may be provided as a perforation on one side of the head main body 141. The guide shaft 153b is inserted into the coupling unit 153a having a hollowed shape to guide the shift of the line head unit 140. However, it is understood that other methods may be used to guide the guide shaft 153b. For example, the guide unit 153 may be provided with one or more guide rails (not shown) on one side of the line head unit 140 to guide the shift of the line head unit 140.

The paper feeding unit 160 stores the print medium R The paper feeding unit 120 transfers the stored print medium P to the line head unit 140 by a paper transferring unit 170. As shown in FIG. 2, the print medium P according to an embodiment of the present invention is transferred in the first direction (x). The second direction (y) denotes the direction of the width of the print medium P. The first direction (x) and the second direction (y) may be provided to be perpendicular to each other. However, the first and the second directions may be provided to be inclined in a predetermined angle.

The paper feeding unit 160 may be provided to be attachable and detachable to/from the image forming apparatus 100, and/or provided to supply the print medium P to the line head unit 140 from an outside.

The paper transferring unit 170 supplies the print medium P to the line head unit 140 for a preset n number of times. The paper transferring unit 170 includes a pick-up roller 171 to pick up the print medium P from the paper feeding unit 160, a transferring roller unit 173 to guide the picked-up print medium P from the pick-up roller 171 to the line head unit 140, and a discharging roller 175 to discharge the image-formed print medium P to the outside. The paper transferring unit 173 receives a driving force from a driving unit 190 to transfer the print medium P. Since the paper transferring unit 173 supplies the image-formed print medium P to the line head unit 140 over the preset n number of times, the pick-up roller 171, the transferring roller unit 173, and the discharging roller unit 175 may be provided to rotate in forward and reverse directions.

The pick-up roller 171 is provided on one side of the paper feeding unit 160. The pick-up roller 171 may apply a friction force to the print medium P stored in the paper feeding unit 160 to pick up the print medium P. The pick-up roller 171 may rotate so as to put pressure on a surface of the print medium P, thereby picking up the print medium P to an outside of the paper feeding unit 160 by the friction force with the print medium P. Also, the pick-up roller 171 can prevent the print medium P from being repeatedly transferred by a repetition prevention member (not shown) provided on an opposite side of the paper feeding unit 161.

The transferring roller unit 173 is provided between the pick-up roller 171 and the line head unit 140. The transferring roller unit 173 rotates in a forward direction to transfer the print medium P picked up by the pick-up roller 171 to the line head unit 140, and rotates in a reverse direction to transfer the image-formed print medium P transferred to the line head unit 140 through the discharging roller unit 175 toward the paper feeding unit 160. The transferring roller unit 173 may align the print medium P so that ink can be jetted on a desirable part of the print medium P before the print medium P passes through the line head unit 140. The transferring roller unit 173 includes a driving roller 173b to supply a transferring force for transferring the print medium P, and an idle roller 173a to rotate while being elastically engaged with the driving roller 173b. The driving roller 173b rotates in forward and reverse directions by the driving unit 190 and the idle roller 173a rotates while being engaged with the driving roller 173b. A plurality of transferring roller units 173 may be provided in consideration of a print medium transferring path between the pick-up roller 171 and the line head unit 140.

The discharging roller unit 175 is provided between the line head unit 140 and the discharging unit 180. The discharging roller unit 175 rotates in a forward direction to discharge the image-formed print medium P to the discharging unit 180, or rotates in a reverse direction to re-supply the image-formed print medium P to the line head unit 140. The discharging roller unit 175 is provided with a star wheel 175a installed in a direction of the width of the print medium P, and a supporting roller 175b provided to be facing the star wheel 175a to support a rear side of the print medium P. Here, the print medium P (on which ink is jetted on an upper surface while passing through the line head 143) may have a wave since the print medium becomes wet due to the ink. If the wave becomes worse, the wet ink spreads when the print medium P contacts the nozzle unit 145 or a bottom of the line head main body 141, thereby distorting the image. Also, the wave may cause a non-uniform gap between the print medium P and the nozzle unit 145.

The star wheel 175a prevents the print medium P transferred through the line head 143 from contacting a surface of the line head main body 141 and/or prevents the gap between the print medium P and the nozzle unit 145 from being changed or made non-uniform. Also, at least one part of the star wheel 175a is projects more than the nozzle unit 145 and dot-contacts an upper side of the print medium P. That is, the star wheel 175a contacts the upper surface of the print medium P, thereby preventing the ink image that is not dried yet after being jetted on the upper surface of the print medium P from being contaminated or spread. Meanwhile, it is understood that a plurality of star wheels 175a may be provided to smoothly transfer the print medium P. Furthermore, a plurality of supporting rollers 175b may be provided to correspond to each star wheel 175a.

The supporting member 177 is provided under the line head 141 and supports a bottom surface of the print medium P so that the nozzle unit 145 and the print medium P can maintain a predetermined gap therebetween.

Meanwhile, as shown in FIG. 2, the paper transferring unit 170, according to an embodiment of the present invention, transfers the print medium P by rotating the plurality of rollers 171, 173, and 175 in forward/reverse directions, but can also employ an electrostatic belt applying an electrostatic force to the print medium P and moving the print medium P attached onto a belt surface thereof. The electrostatic belt using a paper transfer belt (PTB) can move the print medium P from the paper feeding unit 160 to the line head unit 140 by electrification of the belt surface according to the moving direction of the belt, or can re-transfer the image-formed print medium P to the line head unit 140.

In the discharging unit 180, n number of print media on which an image is formed in the line head unit 140 n number of times are discharged and stacked. The discharging unit 180 may include a drying unit (not shown) to dry the image-formed paper.

The driving unit 190 receives power from a power supplying unit (not shown) according to a controlling signal of the controller 200 to drive the paper feeding unit 160, the paper transferring unit 170, and the discharging unit 180. The driving unit 190 is generally provided as a motor and can change rotating directions of the paper feeding unit 160, the paper transferring unit 170, and the discharging unit 180 according to a rotating direction of the motor.

The controller 200 is provided on a mother board of the image forming apparatus 100. The controller 200 controls a jetting operation of the nozzle unit 145 provided in the line head unit 140, the driving unit 190 to control the paper feeding unit 160, a transferring operation, a transferring timing, transferring directions of the paper transferring unit 170, and a shift of the head supporting unit 150.

The controller 200 calculates a best shift of the line head unit 140 to form the optimum printing quality on the print medium P corresponding to the frequency of image forming (n number of times that the image is formed) selected by a user, and controls the head supporting unit 150 to shift the line head unit 140 when images corresponding to the frequency are formed on the basis of the calculated best shift.

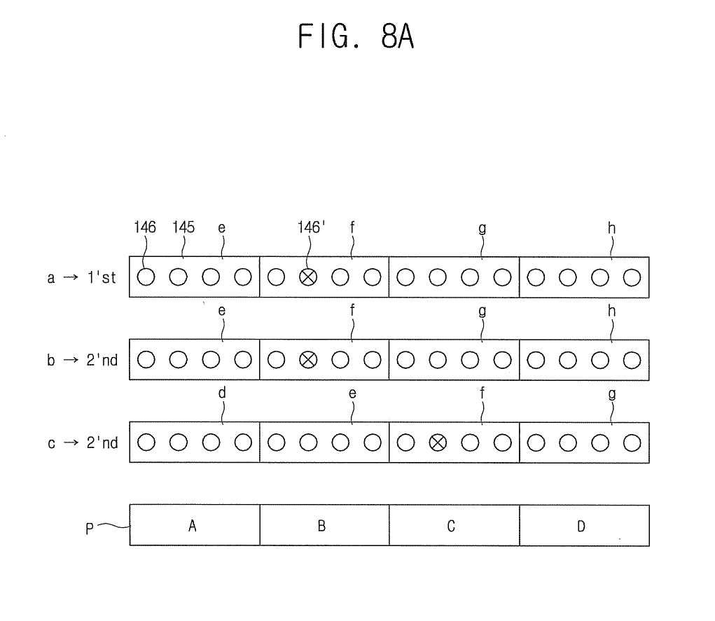

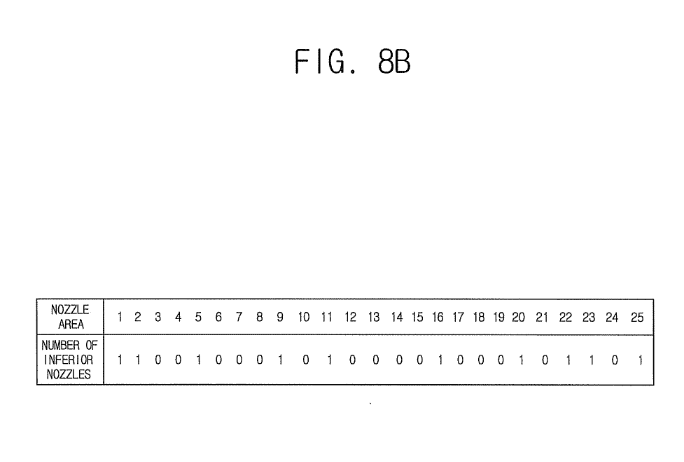

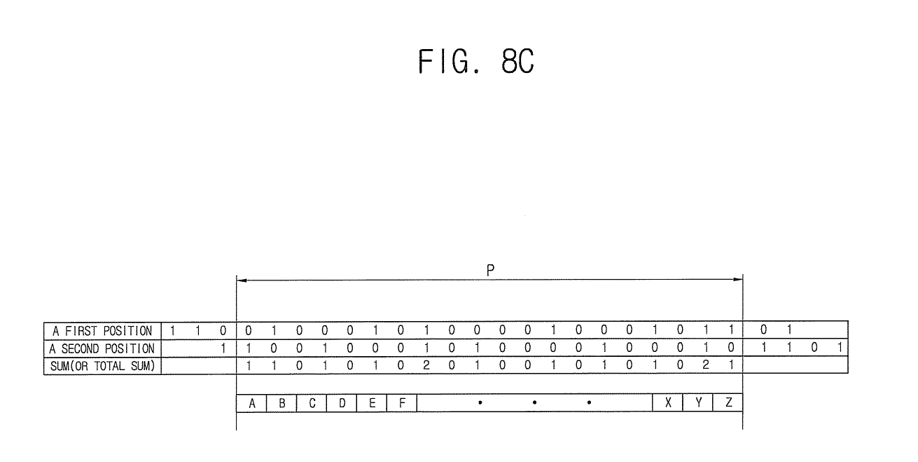

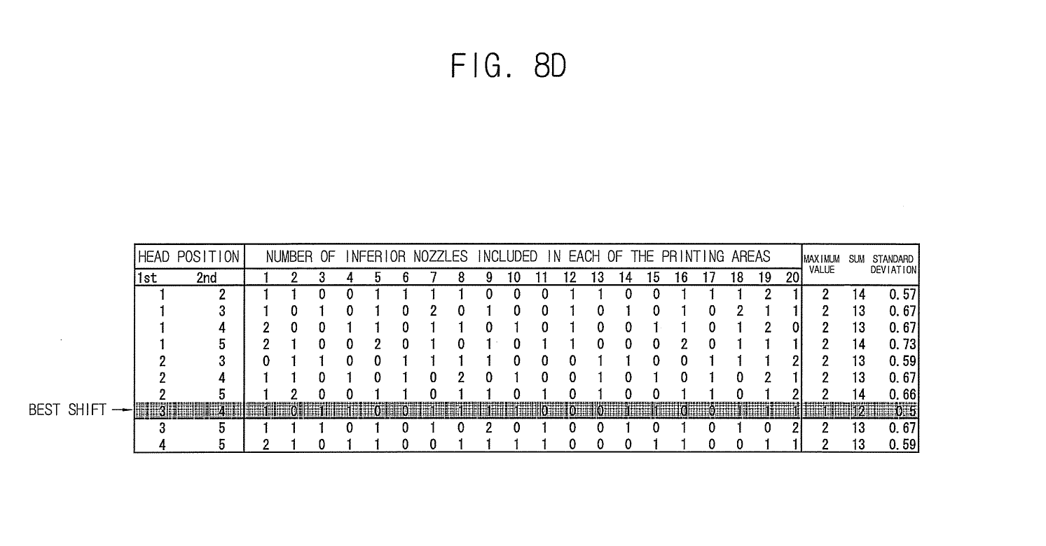

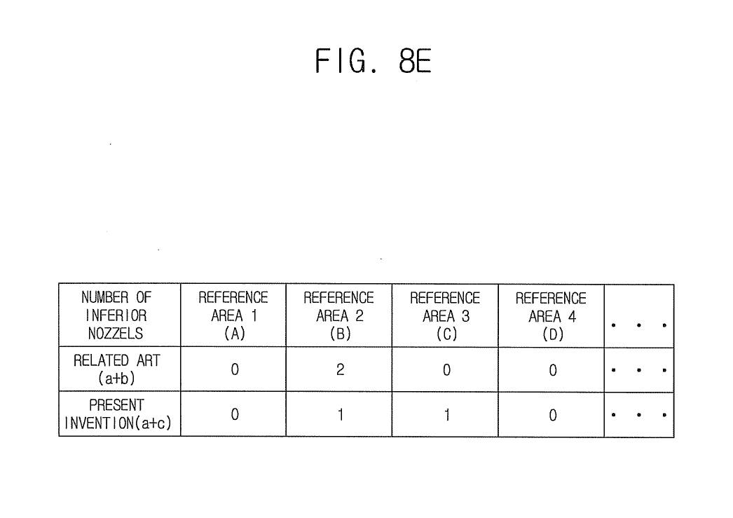

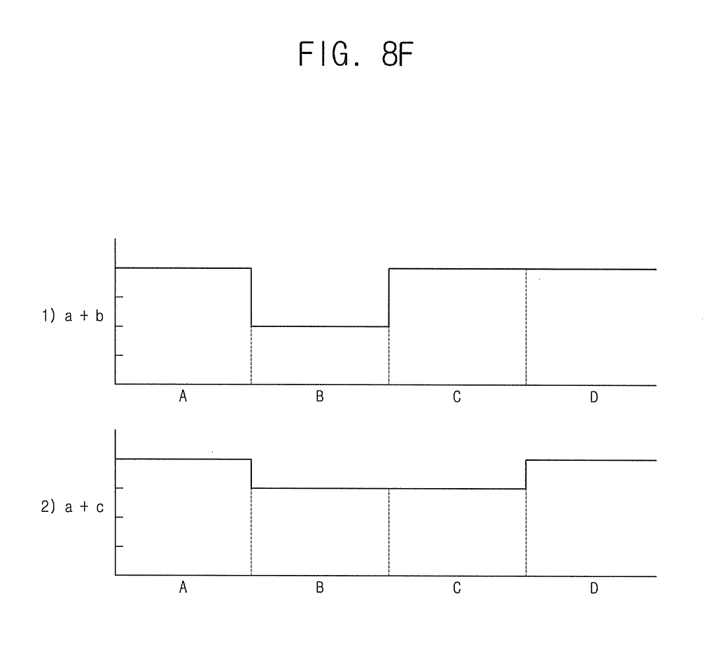

As shown in FIG. 8A, the controller 200 organizes the nozzle unit 145 into a plurality of nozzle areas e, f, g, and h having a predetermined number of nozzles 146. If the nozzle unit 145 includes a plurality of head units 147, the controller 200 organizes the part of the nozzle unit 145 included in the respective head unit 147 into a plurality of nozzle areas e, f, g, and h. At this time, the controller 200 may, although not necessarily, organize the nozzles unit 145 so that two malfunctioning nozzles are not included in one nozzle area in consideration of the ink jetting characteristics of the nozzle unit 145 received through the sensor unit 120. For example, if the ink jetting characteristic includes the number of defective nozzles, and two adjacent nozzles are detected as defective, the controller 200 organizes the nozzle areas on the basis of the two defective nozzles so that the two defective nozzles can be included in different nozzle areas.

The controller 200 may store the ink jetting characteristics including the characteristics of the organized nozzle areas e, f, g, and h in a table, as shown in FIG. 8B. Here, the first row of the table denotes the number (1, 2, 3 . . . ) of the respective nozzle areas, and the second row denotes the ink jetting characteristic of the respective nozzle area. If the ink jetting characteristics include information on the number of defective (or inferior) nozzles, the number of defective nozzles is displayed, and if the ink jetting characteristics include the amount of ink jetting, the amount of ink jetting is displayed. Alternately, if the ink jetting characteristics include a combination of the defective nozzles and the amount of ink jetting, both sets of information on the ink jetting characteristics of the nozzle areas are displayed, respectively.

In addition, as shown in FIG. 8D, the controller 200 calculates the number of possible shifts of the line head unit 140 while the line head unit 140 forms images n number of times, and calculates the ink jetting characteristics of the nozzle areas corresponding to the reference area of the print medium P with respect to each possible shift. Here, the degree or amount to shift the line head unit 140 may be set in units of each nozzle area. That is, as shown in FIG. 8C, a first image is formed in a position where two nozzle areas are shifted, and a second image is formed in a position where four nozzle areas are shifted. At this time, a reference area of the print medium P may be preset as a common area (see an area P in FIG. 8C) in which ink is jetted when the line head unit 140 is minimally and maximally shifted.

Here, the number of possible shifts is determined on the basis of the preset maximum shift and the preset image forming frequency n while the line head unit 140 forms an image n number of times. FIG. 8D is a table that shows the maximum shift corresponding to five nozzle areas, and the sum of the ink jetting characteristics (the number of defective nozzles) corresponding to the reference area of the print medium P when an image is formed over two times. The table excludes configurations in which the line head unit 140 is in the same position without being shifted whenever the image is formed, and the first and the last position are shifted. That is, if the number of the nozzle areas in which the line head unit 140 is maximally shifted is m, and the image is formed over n times, the number of possible shifts can be calculated by the combination of ₘCₙ=m!/(n!(m−n)!).

As shown in FIG. 8D, the first column denotes a position shifted when the line head unit 140 first forms an image, and the second column denotes a position shifted after the line head unit 140 has formed the first image. The figures in the first and the second columns denote the number of the nozzle areas in which the line head unit 140 is shifted. Also, the figures in the rows of the table denote the number of the reference areas of the print medium P. The maximum value denotes the highest ink jetting characteristic included in a reference area of each possible shift, and the sum denotes the sum of the ink jetting characteristics (such as the sum of the defective nozzles) of each possible shift. The maximum value in FIG. 8D denotes the maximum number of defective nozzles included in the nozzle areas corresponding to each reference area, and the sum denotes the sum of the defective nozzles on the entire area of the print medium P. The controller 200 tabularizes the possible shifts, and sets a shift having a minimum difference of the ink jetting characteristic as a best shift. For example, the best shift may be a case in which the number of the defective nozzles in the area having the most defective nozzles is one. Thus, referring to the table illustrated in FIG. 8D, a possible shift in which the first shift is 3 and the second shift is 4 is the best shift.

Meanwhile, when the best shift is determined on the basis of the table, a possible shift having a lowest sum is selected as the best shift if there is a plurality of possible shifts having the same maximum value. Also, if there is a plurality of possible shifts having the lowest sum, the possible shift having the lowest standard deviation may be determined as the best shift. If the value of the standard deviation is at a minimum, the ink jetting characteristics of the nozzle areas corresponding to the respective reference areas may have a value similar to an average value, thereby distributing a uniform printing quality over the whole paper. It is understood that, according to other aspects, the sum and/or the standard deviation may be considered before the maximum value when determining the best shift.

It is understood that the table may be generated differently than the table illustrated in FIG. 8D according to the image forming frequency inputted from a user and the ink jetting characteristics. That is, if the image is formed three or four times, the columns in FIG. 8D may further include possible shifts in which the line head unit 140 is shifted three or four times, and accordingly, the number of possible shifts of the whole line head unit 140 increases.

According to an aspect of the present invention, when the controller 200 organizes the nozzle unit 145 into a plurality of nozzle areas, the number of nozzles 146 included in one nozzle area may, although not necessarily, be between four and eight. If the number of provided nozzles 146 is less than four, the result of the compensation for the ink jetting characteristics made through the shift may be inadequate. If the number of provided nozzles 146 is greater than eight, the number of possible shifts decreases due to the decrease of the number of the nozzle areas. However, it is understood that, according to aspects of the present invention, the controller 200 can organize the nozzle unit 145 into any number of nozzle areas up to the total number of nozzles 146 provided in the nozzle unit 145.

The controller 200 controls the head supporting unit 150, the driving unit 190, and the paper feeding unit 170 so that the image can be formed n number of times according to the determined best shift. As shown in FIG. 8D, the controller 200 controls the line head unit 140 to jet ink onto the print medium P in a state shifted as much as three nozzle areas when the first image is formed, and controls the line head unit 140 to jet ink onto the paper in a state shifted as much as four nozzle areas when the second image is formed.

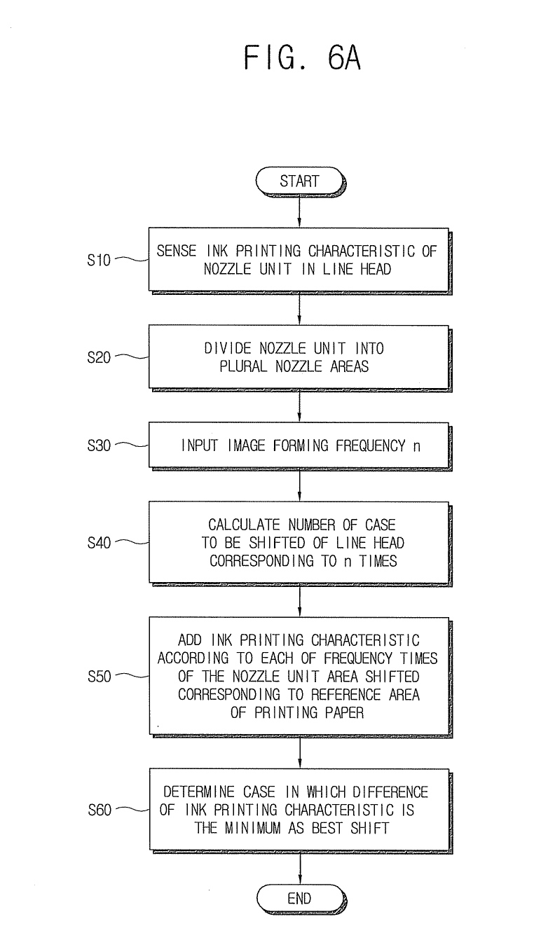

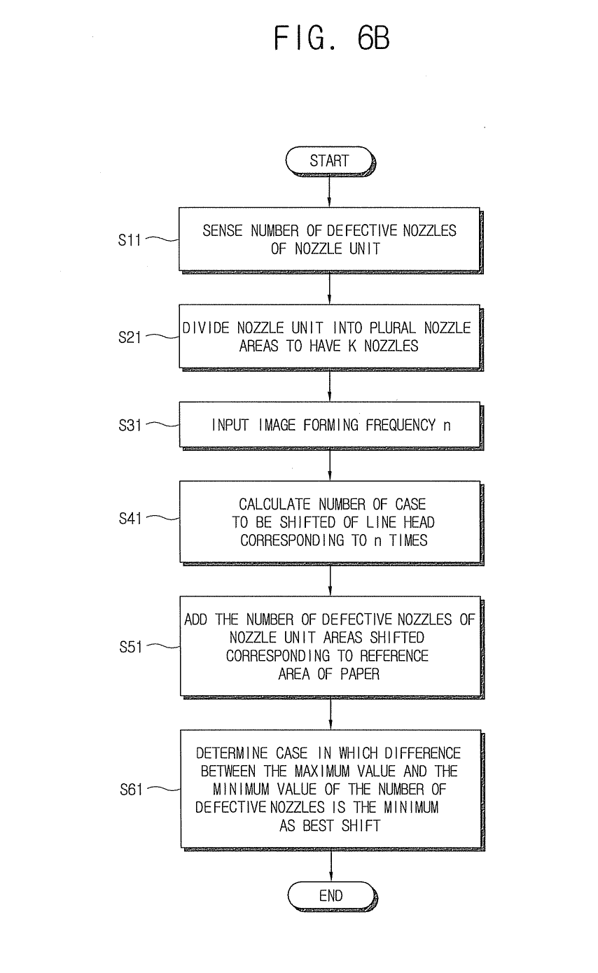

The determining process for the best shift according to an embodiment of the present invention will now be described with reference to FIGS. 6A and 6B. First, in FIG. 6A, the sensor unit 120 senses the ink jetting characteristics of the respective nozzles 146 to inform the controller 200 of the sensed result (operation S10). The controller 200 organizes the nozzles 146 into a plurality of nozzle areas based on the sensed ink jetting characteristics of the nozzles 146 (operation S20). Then, an image forming frequency of n is inputted by a user (operation S30). The image forming frequency is inputted by a user whenever printing is performed, or may be preset as an optimum frequency in the image forming apparatus 100. The controller 200 calculates the number of possible shifts in which the line head unit 140 can be shifted based on the image forming frequency and the maximum shift (operation S40), and tabularizes the sum of the ink jetting characteristics of the nozzle areas shifted corresponding to the reference area of the print medium P (operation S50). The controller 200 sets a best shift according to, for example, the sum of the ink jetting characteristics (operation S60).

FIG. 6B is a flow diagram illustrating a determining process for the best shift if the ink jetting characteristics include the number of defective nozzles, which will be described with reference to FIGS. 8A to 8E. First, the sensor unit 120 senses defective nozzles 146′ of the line head 143 (as illustrated in FIG. 8A) to inform the controller 200 of the sensed result (operation S11). The controller 200 organizes the line head 143 into a plurality of nozzle areas e, f, g, and h such that each of the plurality of nozzle areas e, f, g, and h has four nozzles 146. Also, the controller 200 stores the number of defective nozzles 146 included in the respective nozzle areas as a table (as illustrated in FIG. 8B). The controller 200 calculates the number of possible shifts of the line head unit 140 corresponding to the preset image forming frequency of, in this example, 2, and the maximum shift of, in this example, 5 (operation S51). Also, the controller 200 adds the numbers of defective nozzles included in the nozzle areas shifted as a reference area A, B, C, . . . of the print medium P with respect to each possible shift (as illustrated in FIG. 8D).

The controller 200 selects a possible shift in which the difference between the highest number of defective nozzles and the lowest number of defective nozzles 146 that are included in the reference areas A, B, C, . . . of the print medium P is a minimum among the possible shifts as the best shift (operation S61). Alternately, according to aspects of the present invention, the controller 200 may select a possible shift in which the highest number of defective nozzles included in one reference area from among the reference areas A, B, C, . . . is lower than that of all the other possible shifts as the best shift (operation S61).

Meanwhile, if the ink jetting characteristics include the ink jetting amount for the nozzles 146, the controller 200 stores the amount of ink jetting for each of the nozzle areas e, f, g, and h. The controller 200 may calculate the number of possible shifts of the line head unit 140 and measure in the amount of ink jetting included in the nozzle areas shifted in a reference area of the print medium P when determining the best shift.

At this time, the possible shift in which the difference between the highest amount of ink jetting and the lowest amount of ink jetting included in the reference areas of the print medium P is at a minimum is set as the best shift. According to an aspect of the present invention, if the difference between the highest ink jetting and the lowest ink jetting is the minimum, the ink jetting density can be uniform and the defective nozzles can be compensated for.

Meanwhile, the controller 200 can set, as the ink jetting characteristics, both the number of defective nozzles and the amount of ink jetting. At this time, the sensor unit 120 informs the controller 200 of both the number of defective nozzles and the amount of ink jetting from the nozzles. The controller 200 may generate, for example, a table having two variables (as in FIG. 8B), calculate the number of possible shifts of the line head unit 140, and select the best shift corresponding to the two variables out of the calculated possible shifts. In the above-described case, both the number of defective nozzles and the amount of ink jetting can be compensated for, thereby resulting in an optimum printing quality.

Meanwhile, the controller 200 can set the density of the ink jetted onto the print medium P as the ink jetting characteristic. One out of the maximum density and the minimum density of ink jetted onto the print medium P can be preset. However, since the nozzles 146 are driven at the minimum density, the maximum density may be set as the ink jetting characteristics. The sensor unit 120 scans the print medium P on which ink is jetted and an image is formed to determine and store the ink density of the nozzles corresponding to each of the reference areas of the print medium P in a table. The controller 200 organizes the nozzle unit 145 into the plurality of nozzle areas on the basis of the ink density sensed in the sensor unit 120, and selects the best shift as described above.

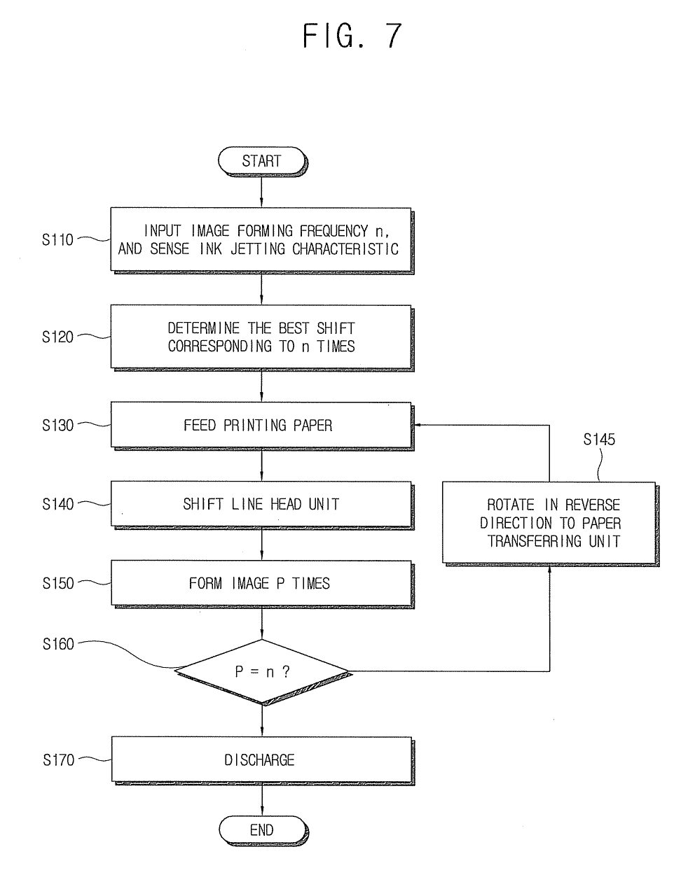

The image forming process of the image forming apparatus 100 having the best shift determined by the above-described process according to aspects of the present invention will now be described with reference to FIG. 7. The image forming frequency n is inputted with an output signal from a host (not shown). Image data to be outputted is received. The sensor unit 120 senses ink jetting characteristics of the respective nozzles 136a and 136b of the line head unit 140 (operation S110). The controller 200 determines the best shift of the line head unit 140 corresponding to the inputted n number of times that the image is formed according to the methods illustrated in FIGS. 6A and 6B (operations S120).

The pick-up roller 171 rotates and picks up the print medium P from the paper feeding unit 160. The print medium P is positioned under the line head 143 via the transferring roller unit 173. It is assumed for a better understanding that the image forming frequency n of the line head unit 140 is two times, and the best shift determined in the controller 200 is three at the first time and four at the second time.

The controller 200 controls the head supporting unit 150 so that the line head unit 140 can be shifted as much as, for example, three nozzle areas. The head driving unit 151 shifts the line head unit 140 as much as three nozzle areas in the second direction along the guide unit 153 (operation S140). The shifted line head unit 140 jets ink onto the print medium P to form an image thereon, and the discharging roller 175 rotates and moves a leading edge of the ink-jetted print medium P toward the discharging unit 180 (operation S150).

If ink is jetted on a trailing edge of the print medium P in the line head unit 140, the controller 200 determines whether the image forming frequency corresponds to the inputted image forming frequency (for example, is two times). If it is determined that the image forming frequency is not, in this example, two times, the controller 200 rotates the transferring roller unit 173 and the discharging roller unit 175 in a reverse direction to transfer the print medium P to the paper feeding unit 160 (operation S145).

The paper re-supplied to the paper feeding unit 160 is supplied to the line head unit 140 by the transferring roller unit 173, and the line head unit 140 is shifted by the head supporting unit 150 as much as the best shift of four at the second time. The shifted line head unit 140 jets ink onto the print medium P to form an image thereon (operation S150).

The controller 200 determines whether the image forming frequency is, in this example, two times, and discharges the print medium P to complete the image forming process (operation S170) if it is determined that the image forming frequency is two times. The ink jetting is equally distributed throughout the ink-jetted print medium P according to the above-described process, thereby obtaining a uniform image quality.

FIG. 8A illustrates the result from comparing ink jetting characteristics between the case in which an image is formed on the print medium P with the line head unit 140 in the same position, and the case in which an image is formed on the print medium P after shifting the line head unit 140 as much as one nozzle area. The nozzle unit 145 is organized into four nozzle areas e, f, g, and h, and the defective nozzle 146′ is included in the second nozzle area f.

FIGS. 8E and 8F are drawings showing the number of defective nozzles 146′ and the amount of ink jetting corresponding to reference areas A, B, C, D of the paper. As shown in FIG. 8E, if an image is formed twice with the line head unit 140 in the same first and second positions (a+b), the amount of ink jetting remarkably decreases in the reference area B in comparison with other areas since two defective nozzles 146′ are overlapped in the reference area B as shown in FIG. 8F. On the other hand, if the image is formed twice with the line head unit 140 in the first position a and in the second position c where the line head unit 140 is shifted from the first position a as much as one nozzle area, respectively, according to an embodiment of the present invention, the amount of ink jetting does not have a big difference from other areas since a defective nozzle 146′ is included once in both the reference area B and the reference area C.

That is, the image forming apparatus according to aspects of the present invention can compensate for ink jetting characteristics by jetting ink onto a print medium P several times after shifting the line head unit. Accordingly, the image forming apparatus according to an embodiment of the present invention can solve a problem that a printing quality of the print medium P is not uniform due to a difference of ink jetting characteristics among nozzles. As a result, an image distortion, such as a white line, easily recognized by a user after forming the image can be compensated for.

Furthermore, the defective nozzles are compensated for according to the type of information included in the ink jetting characteristics, or the density can be selectively improved, thereby enhancing the image quality. Also, a method of compensating for the defective nozzles, according to aspects of the present invention, organizes the nozzle unit into a plurality of nozzle areas, each having a predetermined number of nozzles, thereby decreasing time necessary for the compensation of the defective nozzles.

While not required, aspects of the invention can be implemented using software and/or firmware stored on a computer readable medium for use with a computer and/or processor.

As described above, the image forming apparatus according to aspects of the present invention forms an image on a print medium a plurality of times and minimizes the difference in the ink jetting characteristics among the respective nozzles to secure an image printing quality. Moreover, the image forming apparatus can move the line head unit to the sub scanning direction of the print medium when forming an image, and decrease the ink jetting characteristic difference among the nozzles.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An image forming apparatus, comprising:
a line head unit comprising a nozzle unit that comprises a plurality of nozzles;
a head supporting unit to shift the line head unit; and
a controller to control the head supporting unit to shift the line head unit when forming an image on a print medium according to ink jetting characteristics among nozzles corresponding to reference areas of the print medium, where each of the reference areas is a portion of the print medium on which the image is formed.

2. The image forming apparatus as claimed in claim 1, further comprising:
a transferring unit to supply the print medium to the line head unit in a first direction n number of times so that the image can be repeatedly formed the n number of times.

3. The image forming apparatus as claimed in claim 2, wherein the head supporting unit shifts the line head unit in a second direction, other than the first direction, for the n number of times.

4. The image forming apparatus as claimed in claim 1, wherein:
the nozzle unit is organized into a plurality of nozzle areas, each nozzle area comprising a number of the nozzles; and
the controller controls the head supporting unit to shift the line head unit when forming the image to minimize a difference of ink jetting characteristics among nozzle areas corresponding to the reference areas of the print medium.

5. The image forming apparatus as claimed in claim 4, wherein the ink jetting characteristics comprise a number of defective nozzles included in each of the plurality of nozzle areas, an amount of ink jetted in each of the plurality of nozzle areas, an image density on the print medium corresponding to each of the plurality of nozzle areas, or combinations thereof.

6. The image forming apparatus as claimed in claim 3, wherein:
the nozzle unit is organized into a plurality of nozzle areas, each nozzle area comprising a number of the nozzles; and
the controller controls the head supporting unit to shift the line head unit when forming the image to minimize a difference of ink jetting characteristics among nozzle areas corresponding to the reference areas of the print medium over the n number of times.

7. The image forming apparatus as claimed in claim 1, wherein:
the controller controls the head supporting unit to shift the line head unit when forming the image to minimize a highest number of defective nozzles included in one reference area from among the reference areas of the print medium.

8. The image forming apparatus as claimed in claim 1, wherein:
the controller controls the head supporting unit to shift the line head unit when forming the image to minimize a total number of defective nozzles included in all the reference areas of the print medium.

9. The image forming apparatus as claimed in claim 1, further comprising:
a sensor unit to sense the ink jetting characteristics of each of the nozzles; and
a storing unit to store the ink jetting characteristics of each of the nozzles sensed by the sensor unit.

10. The image forming apparatus as claimed in claim 6, wherein:
the controller calculates a number of possible shifts in which the line head unit can be shifted on the basis of the n number of times that the image is formed and the number of the nozzles included in each of the nozzle areas;
adds, for each of the nozzle areas corresponding to the reference areas of the print medium in each of the possible shifts, the ink jetting characteristics of the respective nozzle area;
determines a best shift where the difference of the added ink jetting characteristics among the nozzle areas corresponding to the reference areas of the print medium is a lowest value from among each of the possible shifts; and
controls the head supporting unit to shift the line head unit according to the best shift.

11. The image forming apparatus as claimed in claim 10, wherein when the ink jetting characteristics comprise a number of defective nozzles and the difference of the ink jetting characteristics is the lowest value for more than one of the possible shifts, the controller determines the best shift where a number of the defective nozzles in the nozzle areas corresponding to the reference areas of the print medium is a lowest value from among each of the possible shifts.

12. The image forming apparatus as claimed in claim 10, wherein when the ink jetting characteristics comprise an amount of ink jetted through the nozzles and the difference of the ink jetting characteristics is the lowest value for more than one of the possible shifts, the controller determines the best shift where a sum of the amount of ink jetted in the nozzle areas corresponding to the reference areas of the print medium is a highest value from among each of the possible shifts.

13. The image forming apparatus as claimed in claim 1, wherein the nozzle unit comprises a plurality of head units each comprising one or more nozzles.

14. The image forming apparatus as claimed in claim 13, wherein the line head unit has a width that is greater than a width of the print medium by at least a half of a width of one head unit.

15. The image forming apparatus as claimed in claim 1, wherein the controller controls the head supporting unit to shift the line head unit by at least one nozzle area.

16. The image forming apparatus as claimed in claim 4, wherein:
the controller organizes the nozzle unit into the plurality of nozzle areas so that a first nozzle having a first ink jetting characteristic is placed in a first nozzle area and a second nozzle having a second ink jetting characteristic is placed in a second nozzle area; and
the first ink jetting characteristic and the second ink jetting characteristic are different than a predetermined ink jetting characteristic.

17. The image forming apparatus as claimed in claim 4, wherein the controller controls the head supporting unit to shift the line head unit by at least one nozzle area.

18. The image forming apparatus as claimed in claim 5, wherein:
the controller calculates a number of possible shifts in which the line head unit can be shifted on the basis of the n number of times that the image is formed and the number of the nozzles included in each of the nozzle areas;
adds, for each of the nozzle areas corresponding to the reference areas of the print medium in each of the possible shifts, the ink jetting characteristics of the respective nozzle area;
determines a best shift where the difference of the added ink jetting characteristics among the nozzle areas corresponding to the reference areas of the print medium is a lowest value from among each of the possible shifts; and
controls the head supporting unit to shift the line head unit as according to the best shift.

19. The image forming apparatus as claimed in claim 18, wherein when the ink jetting characteristics comprise the number of the defective nozzles and the difference of the ink jetting characteristics is the lowest value for more than one of the possible shifts, the controller determines the best shift where a number of the defective nozzles in the nozzle areas corresponding to the reference areas of the print medium is a lowest value from among each of the possible shifts.

20. The image forming apparatus as claimed in claim 18, wherein when the ink jetting characteristics comprise the amount of ink jetted through the nozzles and the difference of the ink jetting characteristics is the lowest value for more than one of the possible shifts, the controller determines the best shift where a sum of the amount of ink jetted in the nozzle areas corresponding to the reference areas of the print medium is a highest value from among each of the possible shifts.

21. The image forming apparatus as claimed in claim 18, wherein the nozzle unit comprises a plurality of head units each comprising one or more nozzles.

22. The image forming apparatus as claimed in claim 21, wherein the line head unit has a width that is greater than a width of the print medium by at least a half of a width of one head unit.

23. The image forming apparatus as claimed in claim 21, wherein the controller controls the head supporting unit to shift the line head unit by at least one nozzle area.

24. The image forming apparatus as claimed in claim 23, wherein the controller controls the head supporting unit so that a maximum single shift of the line head unit can not exceed a fourth of a width of one head unit.

25. The image forming apparatus as claimed in claim 4, wherein the controller organizes the nozzle unit into the plurality of nozzle areas so that each of the nozzle areas comprises at least four of the nozzles.

26. A method of forming an image on a print medium, the method comprising:
determining ink jetting characteristics of nozzles comprised in a nozzle unit provided in a line head unit; and
shifting the line head unit when forming the image according to the ink jetting characteristics of ones of the nozzles corresponding to reference areas of the print medium, where each of the reference areas is a portion of the print medium on which the image is formed.

27. The method as claimed in claim 26, further comprising:
supplying the print medium to the line head unit in a first direction n number of times so that the image can be repeatedly formed the n number of times,
wherein the shifting of the line head unit comprises:
shifting the line head unit in a second direction, other than the first direction, for the n number of times.

28. The method as claimed in claim 26, further comprising:
organizing the nozzle unit into a plurality of nozzle areas, each comprising a number of the nozzles,
wherein the shifting of the line head unit comprises:
shifting the line head unit when forming the image to minimize a difference of ink jetting characteristics among nozzle areas corresponding to the reference areas of the print medium.

29. The method as claimed in claim 28, wherein the ink jetting characteristics comprise a number of defective nozzles included in each of the plurality of nozzle areas, an amount of ink jetted in each of the plurality of nozzle areas, an image density on the print medium corresponding to each of the plurality of nozzle areas, or combinations thereof.

30. The method as claimed in claim 27, further comprising:
organizing the nozzle unit into a plurality of nozzle areas, each comprising a number of the nozzles,
wherein the shifting of the line head unit in the second direction comprises:
shifting the line head unit when forming the image to minimize a difference of ink jetting characteristics among nozzle areas corresponding to the reference areas of the print medium.

31. The method as claimed in claim 26, wherein the shifting of the line head unit comprises:
shifting the line head unit when forming the image to minimize a highest number of defective nozzles included in one reference area from among the reference areas of the print medium.

32. The method as claimed in claim 26, wherein the shifting of the line head unit comprises:
shifting the line head unit when forming the image to minimize a total number of defective nozzles included in all the reference areas of the print medium.

33. The method as claimed in claim 26, wherein the determining of the ink jetting characteristics comprises:
sensing the ink jetting characteristics of each of the nozzles; and
storing the sensed ink jetting characteristics.

34. The method as claimed in claim 30, wherein the shifting of the line head unit when forming the image to minimize the difference of the ink jetting characteristics among the nozzle areas corresponding to the reference areas of the print medium comprises:
calculating a number of possible shifts in which the line head unit can be shifted on the bases of the n number of times that the image is formed and the number of the nozzles included in each of the nozzle areas;
adding, for each of the nozzle areas corresponding to the reference areas of the print medium in each of the possible shifts, the ink jetting characteristics of the respective nozzle area;
determining a best shift where the difference of the added ink jetting characteristics among the nozzle areas corresponding to the reference areas of the print medium is a lowest value from among each of the possible shifts; and
shifting the line head unit according to the best shift.

35. The method as claimed in claim 34, wherein the shifting of the line head unit when forming the image to minimize the difference of the ink jetting characteristics among the nozzle areas corresponding to the reference areas of the print medium further comprises:
determining the best shift where a number of defective nozzles in the nozzle areas corresponding to the reference areas of the print medium is a lowest value from among each of the possible shifts when the ink jetting characteristics comprise the number of the defective nozzles and the difference of the ink jetting characteristics is the lowest value for more than one of the possible shifts.

36. The method as claimed in claim 34, wherein the shifting of the line head unit when forming the image to minimize the difference of the ink jetting characteristics among the nozzle areas corresponding to the reference areas of the print medium further comprises:
determining the best shift where a sum of an amount of ink jetted in the nozzle areas corresponding to the reference areas of the print medium is a highest value from among each of the possible shifts when the ink jetting characteristics comprise the amount of ink jetted through the nozzles and the difference of the ink jetting characteristics is the lowest value for more than one of the possible shifts.

37. The method as claimed in claim 28, wherein:
the organizing of the nozzle unit comprises:
organizing the nozzle unit into the plurality of nozzle areas so that a first nozzle having a first ink jetting characteristic is placed in a first nozzle area and a second nozzle having a second ink jetting characteristic is placed in a second nozzle area; and
the first ink jetting characteristic and the second ink jetting characteristic are different than a predetermined ink jetting characteristic.

38. A computer readable recording medium encoded with the method of claim 26 implemented by a computer.
